(19) United States
(12) Patent Application Publication
(10) Pub. No.: US 2011/0037530 A1
(43) Pub. Date: Feb. 17, 2011

(54) STRIPLINE TO WAVEGUIDE PERPENDICULAR TRANSITION

(75) Inventors: Sankara N. Mangalahgari, Singapore (SG); Kiat C. Teo, Sigapore (SG); Binghua Pan, Singapore (SG); Wun Leng Lee, Singapore (SG)

Correspondence Address: Delphi Technologies, Inc., M/C 480-410-202, P.O. Box 5052, Troy, MI, 48007, US

(73) Assignee: DELPHI TECHNOLOGIES, INC., Troy, MI (US)

(21) Appl. No.: 12/538,931

(22) Filed: Aug. 11, 2009

(51) Int. Cl. H01P 5/107

(52) U.S. Cl. 333/26

(57) ABSTRACT

A stripline to waveguide transition is provided that includes a shielded stripline having a transmission line in a dielectric, between two ground planes. The transition includes a stripline patch electrically coupled to the transmission line within an opening of the first ground plane and a stripline impedance matching transformer. The transition further includes a waveguide comprising a waveguide wall defining a waveguide opening. The waveguide is arranged substantially perpendicular to the patch, and the waveguide opening is aligned with an opening in the first ground plane. The electric field of the stripline transitions to a transverse electric propagation in the waveguide. The transition may be integrated with a transceiver and antenna.

### TECHNICAL FIELD

The present invention generally relates to the transmission of radio frequency (RF) energy, and more particularly relates to the transition that efficiently transfers RF energy between a shielded stripline and waveguide.

### BACKGROUND OF THE INVENTION

Waveguides and antenna feed networks are employed in RF systems that operate in various microwave or millimeter wave frequency bands such as automotive radar, according to one example. A transition is employed for the efficient transfer of RF energy propagating in transverse electromagnetic (TEM) mode in a stripline to TE₁₀ mode of propagation in a waveguide.

Microstrip to waveguide transitions have been employed that are typically fabricated on Teflon® based substrates with ground metallization on one side of the substrate and air-cavity in the supporting aluminum block on the other side. Expensive absorbers are often used to suppress unwanted coupling within the feed network due to cavity modes. As a result, the microstrip implementation generally adds to the overall cost of the feed network.

Accordingly, it is desirable to provide for an efficient and cost-effective transition of RF energy between the TEM mode and TE₁₀ mode.

### SUMMARY OF THE INVENTION

In accordance with one aspect of the present invention, a stripline to waveguide transition is provided. The transition includes a stripline comprising a conductive transmission line disposed between first and second ground planes and dielectrically isolated therefrom by a dielectric. The transition also includes a conductive patch electrically coupled to the conductive transmission line within an opening in the first ground plane. The transition further includes a waveguide comprising a waveguide wall defining a waveguide opening. The waveguide is arranged substantially perpendicular to the conductive stripline patch. The waveguide opening is aligned with the opening in the first ground plane and electrically coupled to the waveguide, wherein the electric field of the stripline transitions to a transverse electric propagation in the waveguide. The RF energy transitions between a TEM mode propagation in the stripline and a TE₁₀ mode propagation in the waveguide.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a cross-sectional view of a transceiver device employing a stripline to waveguide transition, according to one embodiment;

FIG. 2 is a perspective view of the stripline to waveguide transition, according to one embodiment;

FIG. 3 is a graph illustrating simulated results achieved with the stripline to waveguide transition shown in FIG. 2;

FIG. 4 is a perspective view of a stripline to waveguide transition, according to another embodiment; and

FIG. 5 is a graph illustrating the simulated results achieved with the stripline to waveguide transition shown in FIG. 4.

### DESCRIPTION OF THE PREFERRED EMBODIMENTS

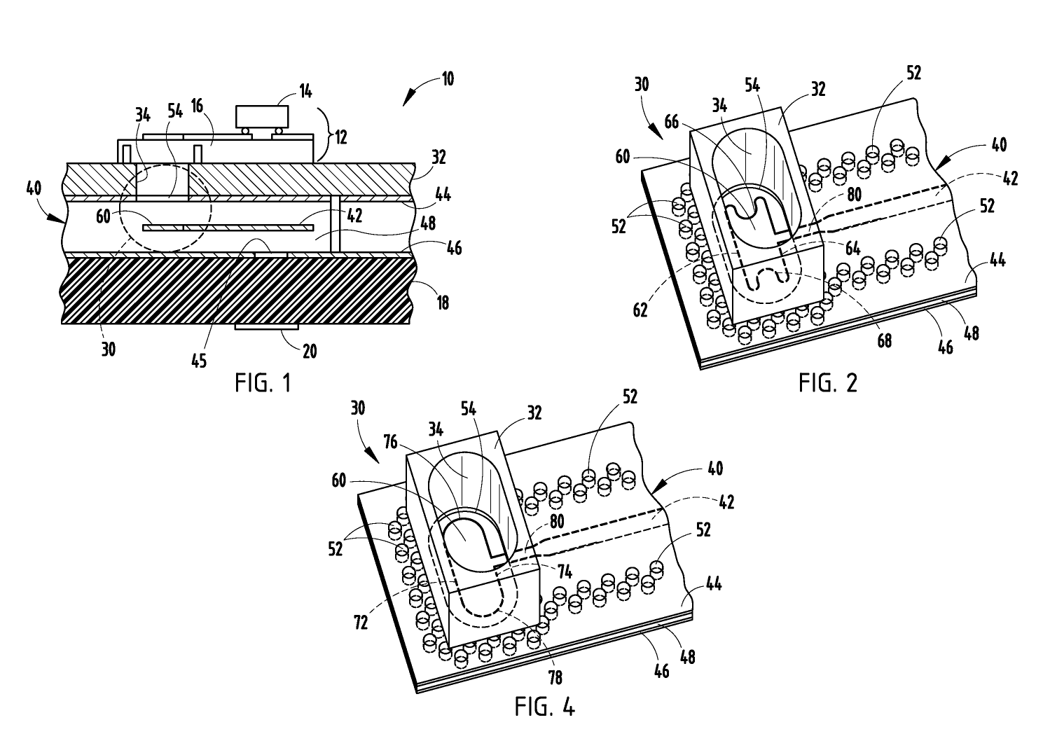

Referring to FIG. 1, a cross-sectional view of an RF system 10 is generally illustrated comprising a transceiver device or module 12, mounted on an aluminum block 32, coupled through a waveguide 34 in the block 32, followed by a transition 30 to a stripline 40 having stripline feed network 42. The stripline 40 and waveguide 34 are arranged substantially perpendicular (ninety degrees) to each other. The RF system 10 also includes an antenna or radiator 20. The stripline to waveguide transition 30 transitions RF energy between TEM mode propagation in the stripline 40 and TE₁₀ mode propagation in the waveguide 34. The RF system 10 may transmit and receive RF energy for use in various systems, such as an automotive radar system, according to one embodiment.

The transceiver device 12 may include a monolithic millimeter wave integrated circuit (MMIC) 14 mounted onto a low temperature co-fired ceramic (LTCC) substrate 16. MMIC 14 may include one or more amplifiers, mixers, and other electrical circuitry. The substrate 16 is shown mounted on the conductive block 32 which has the waveguide 34 formed therein. The waveguide 34 may be realized in aluminum/copper/FR4 or any other rigid support, according to various embodiments. The waveguide 34 is perpendicular to the stripline 40 and its transmission line 42. The stripline 40 includes a conductive strip or transmission line 42 separated from first (upper) and second (lower) ground planes 44 and 46 by a dielectric 48 such that line 42 is sandwiched by the dielectric 48. RF energy is coupled to the antenna or radiator strip 20 on the antenna dielectric substrate 18 through an aperture 45 in the bottom ground plane 46, according to one embodiment. According to other embodiments, a slot radiator or other radiator may be employed.

The stripline 40 is a shielded transmission line with conductive strip 42 sandwiched between two dielectric substrates 48, with ground metallization 44 and 46 on either sides of the structure. As there is no need of air-cavity and absorber material, a properly designed stripline 40 offers a cost-effective implementation of the feed network, apart from certain electrical advantages. The stripline 40 is connected by its transmission line 42 to a conductive stripline patch 60.

Referring to FIG. 2, the stripline to waveguide transition 30 is further illustrated in more detail and is shown absent other components of the RF system 10. The waveguide 34 is generally shown as a rectangular hole with rounded corners, with conductive inner walls, often constructed in a block of conductive material, such as aluminum/copper or rigid substrate materials such as FR4 or other dielectric with conductive plated inner walls. The waveguide 34 extends from the bottom of the transceiver 12 to a waveguide opening 54 in the upper ground plane 44 of the stripline 40 and is aligned perpendicular to the stripline patch 60.

The stripline 40 is shown having the conductive transmission line 42 separated from and sandwiched between the first and second ground planes 44 and 46 by the intermediate dielectric 48. As such, the conductive transmission line 42 is electrically isolated from the upper and lower ground planes 44 and 46 which electrically shield the transmission line 42. The opening 54 is formed in the upper ground plane 44 of the stripline 40 by etching the metallization in the ground plane 44 to remove an area of the upper ground plane 44 of the stripline 40 to form the opening 54 that generally aligns with the waveguide opening 34.

The stripline patch 60 is formed of a conductive material fabricated on the dielectric 48 of the stripline 40 and is electrically coupled to the transmission line 42 through an impedance matching transformer 80. The transmission line 42 connects to the impedance matching transformer 80 which has a tapered portion and has a predetermined impedance, e.g., 50 ohms. The stripline patch 60 may be integrally formed with the transmission line 42. The stripline patch 60 is shown in the first embodiment in a generally dog bone shape having substantially parallel opposing sides 62 and 64 and inwardly protruding U-shaped opposing ends 66 and 68. The shape and dimensions of the stripline patch 60 may be optimized for efficient transfer of RF signals in the required signal band. The conductive stripline patch 60 is electrically coupled to the conductive strip 42 and is electrically coupled to the overlying waveguide 34 such that the electric field transitions between TEM mode of the stripline 40 and a TE₁₀ mode in the waveguide 34.

The stripline 40 is further shown having a plurality of plated via holes 52 extending between the top and bottom ground planes 44 and 46 generally located around the outside of the stripline patch 60 and the transmission line 42 so as to form a fence along the stripline 40 that minimizes undesirable parallel plate modes. The plurality of via holes 52 may be formed in two roles, generally offset from one another, according to the embodiment shown. According to another embodiment, the plurality of via holes 52 may be formed as a single row. It should be appreciated that the plurality of vias 52 may be provided in various numbers, orientations and shapes may further be provided with a conductive plating to form conductive vias. The dielectric 48 may have a thickness and the via hole fence may have a width (edge-to-edge) distance between via hole rows on either side of the stripline 40, as desired to provide proper functioning of the stripline.

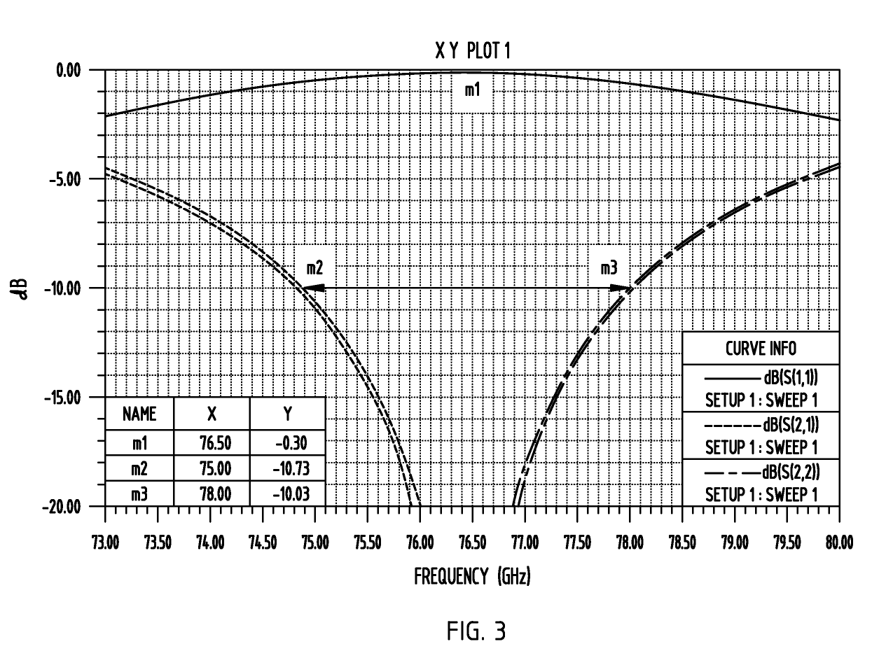

Referring to FIG. 3, a graph illustrates simulated results of the S-parameters in decibels (dB) versus frequency in gigahertz (GHz) for RF signal transitions achieved with the stripline to waveguide transition 30 shown in FIG. 2.

The specific stripline to waveguide transition was designed at a nominal frequency of seventy-six and one-half gigahertz (76.5 GHz), according to one example. As shown, the stripline to waveguide transition advantageously transitions RF signals between the waveguide and stripline in an efficient manner centered about a frequency of about seventy-six and one-half gigahertz (76.5 GHz).

Referring to FIG. 4, a stripline to waveguide transition 30 is illustrated according to another embodiment. In this embodiment, the conductive stripline patch 60 is shown having a generally oval shape with parallel or slightly rounded opposing sides 72 and 74 and rounded opposing ends 76 and 78, in contrast to the dog bone shape of the first embodiment. It should be appreciated that the conductive stripline patch 60 may be configured having various shapes and sizes which may be optimized for efficient transfer of RF signals in the required operating bandwidth. While dog bone shape and oval shape stripline patches 60 are illustrated in the embodiments shown, it should be appreciated that other sizes and shapes, such as a dumbbell shape patch may be provided, according to other embodiments.

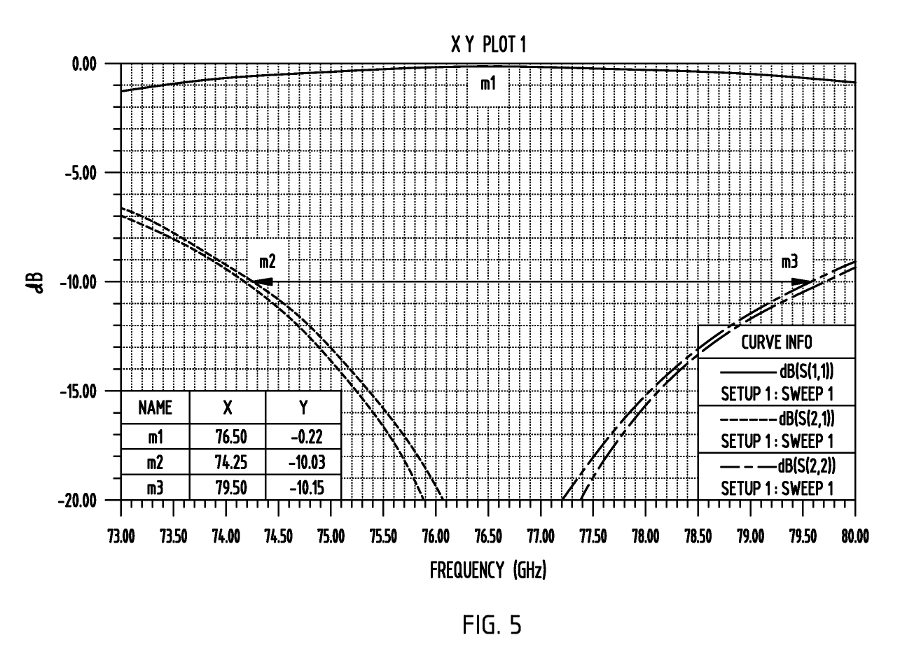

Referring to FIG. 5, a graph illustrates simulated results in decibels (dB) versus frequency in gigahertz (GHz) for RF signal transitions achieved with the stripline to waveguide transition 30 shown in FIG. 4. As can be seen, the stripline to waveguide transition 30 provides an efficient transition of RF energy centered about a frequency of seventy-six and one-half gigahertz (76.5 GHz).

Accordingly, the stripline to waveguide transition 30 advantageously provides for transition or transfer of RF energy from TEM mode of propagation in stripline 40 to the transverse electric propagation of the waveguide 34. The stripline to waveguide transition 30 advantageously does not require an expensive air-cavity to be machined into the supporting aluminum block, nor does it require an expensive absorber material. Additionally, the transition 30 may advantageously be effectively integrated within an antenna and transceiver in a single multilayer substrate.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

1. A stripline to waveguide transition comprising:
a stripline comprising a conductive transmission line disposed between first and second ground planes and dielectrically isolated therefrom by dielectric;
a conductive stripline patch electrically coupled to the conductive transmission line within an opening in the first ground plane; and
a waveguide comprising a waveguide wall defining a waveguide opening, said waveguide wall arranged substantially perpendicular with the conductive stripline patch, said waveguide opening aligned with the opening in the first ground plane, wherein RF energy transitions between a TEM mode propagation in the stripline and a TE₁₀ mode propagation in the waveguide.

2. The transition as defined in claim 1 further comprising an impedance matching transformer coupled between the conductive stripline patch and the conductive transmission line.

3. The transition as defined in claim 2, wherein the impedance matching transformer comprises a tapered portion and has a predetermined impedance.

4. The transition as defined in claim 1 further comprising a plurality of conductive vias extending through the stripline on opposite sides of the conductive transmission line to form a fence that minimizes undesirable parallel plate mode propagation of electric signals.

5. The transition as defined in claim 1, wherein the conductive stripline patch has a dog bone shape.

6. The transition as defined in claim 1, wherein the conductive stripline patch has an oval shape.

7. The transition as defined in claim 1, wherein the first ground plane is on one side of the conductive transmission line and the second ground plane is on an opposite side of the conductive transmission line, and wherein the dielectric is disposed between the conductive transmission line and each of the first and second ground planes.

8. The transition as defined in claim 1, wherein the waveguide comprises a conductive material.

9. The transition as defined in claim 8, wherein the waveguide comprises at least one of aluminum and copper.

10. The transition as defined in claim 8, wherein the waveguide comprises a dielectric with conductive plated walls.

11. The transition as defined in claim 1, wherein the transition is employed in a waveguide to antenna through stripline feed network.

12. The transition as defined in claim 11, wherein the transition operates at a frequency of approximately 77 gigahertz.
